(19) United States
(12) Patent Application Publication
(10) Pub. No.: US 2023/0225835 A1
(43) Pub. Date: Jul. 20, 2023

(54) MAXILLARY SKELETAL EXPANDER DEVICE (M-MARPE) AND METHOD

(71) Applicants: Paul Kim, Norwalk, CA (US); Won Moon, Norwalk, CA (US)

(72) Inventors: Paul Kim, Norwalk, CA (US); Won Moon, Norwalk, CA (US)

(21) Appl. No.: 18/121,044

(22) Filed: Mar. 14, 2023

Related U.S. Application Data
(63) Continuation-in-part of application No. 16/556,432, filed on Aug. 30, 2019.
Application No. 16/556,432 is a continuation-in-part of application No. 16/394,846, filed on Apr. 25, 2019.
Application No. 16/394,846 is a continuation-in-part of application No. 16/851,851, filed on Apr. 17, 2020.
Application No. 16/851,851 is a continuation-in-part of application No. 16/556,432, filed on Aug. 30, 2019.
Application No. 16/556,432 is a continuation-in-part of application No. 16/394,846, filed on Apr. 25, 2019.

(51) Int. Cl. A61C 7/10

(52) U.S. Cl. CPC A61C 7/10

(57) ABSTRACT

The present invention discloses a maxillary skeletal expander device (“M-MARPE”) that provides for enhanced effectiveness of maxillary skeletal expansion, enhanced oral comfort, or oral cleaning. Also disclosed are methods of making and using the M-MARPE device.

### CROSS-REFERENCE TO RELATED APPLICATION

This application is a continuation-in-part of U.S. application Ser. No. 16/556,432, filed Aug. 30, 2019, which, in turn, is a continuation-in-part of U.S. application Ser. No. 16/394,846, filed Apr. 25, 2019. The teachings of these applications are incorporated herein by reference in their entirety.

### FIELD OF THE INVENTION

The present disclosure generally relates an orthodontic device and more specifically a device for expanding upper jaw of a patient, and more particularly to maxillary skeletal expanders.

### BACKGROUND OF THE INVENTION

Traditionally, orthodontists have used a Rapid Palatal Expander (“RPE”) attached to an orthodontic appliance to force an expansion between the plates in the palatal bone. While this technique is frequently used, the success of using such method on adult patients is minimal due to the development of bone density of the palatal region. U.S. Pat. No. 9,351,810 to Dr. Moon addresses this complication in adult patients by incorporating micro-implants into the RPE orthodontic appliance (“MARPE”). The micro-implants serve as additional anchorage points, which allows the RPE to exert far greater force in moving the plates in the palatal bone than without the micro-implants. These micro-implants are anchored, or screwed in, to the palatal bone directly from four holes made directly in the RPE appliance. The essential components of the MARPE include the RPE and four welded arms that are attached to two molar bands. The RPE is the “engine” behind the appliance, and is engaged by turning a gear mechanism that exerts outward force onto the palatal bone and surrounding teeth, thereby causing an expansion between the two plates of the palatal bone.

U.S. Pat. No. 9,351,810's FIGS. 3-5, describes the maxillary skeletal expander by Moon using mini-screws, which includes a two halves of the device body 100, arms 200 having one end fixed to the bodies 100 and the other end extending toward teeth B, an extending screw 300 having both side portions inserted into the two halves of the device body 100 to adjust a space between the two halves of the device body 100, guide rails 400 having both sides inserted into the two halves of the device body 100 and guiding a movement of the device 100, a key hole 500 integrally formed with the extending screw 300, screw insertion portions 110 integrally formed with the bodies 100 and having screw insertion holes 112 guiding mini-screws S implanted to an upper jaw, and a teeth fixing part 600 integrally formed with the arms 200 and fixed to teeth of a patient.

There are a number of shortcomings in the MARPE device. For example, there is a gap between the hole in the RPE (where the micro-implants are inserted) and the palatal region, thus allowing (1) room for potential error during the implantation process, (2) a greater likelihood of food particles being caught and causing bad breath and poor oral hygiene, and (3) external forces to shake the mini-implant out of place. U.S. application Ser. No. 15/680,036, filed Aug. 17, 2017, discloses a MARPE device (M-MARPE) that addresses these shortcomings in the MARPE device.

However, the need for a more effective RPE device remains. Additionally, patient/user inconveniences with regard to having a foreign object affixed to the palatine bone remains un-addressed. Such a foreign object would lead the tongue of a patient to touch and play around the object, which could cause the affixation of the RPE device to the palatine bone to lose or even fall apart. Further, oral hygiene remains a major concern as segmentation of a RPE device would cause food particles to be trapped in the crevices between the segments of the RPE device.

Therefore, it is an object of the present disclosure to provide a more effective RPE device.

It is a further object of the present disclosure to provide an RPE device that minimizes device segmentation.

It is a further object of the present disclosure to provide a RPE device that minimizes oral hygiene issues.

The embodiments below address the above described issues, needs, and/or objects.

### SUMMARY OF THE INVENTION

In one aspect of the present disclosure, it is provided a maxillary skeletal expander device, comprising:

two halves of a device body, each half having a left side and a right side, a middle portion, and at least an anchoring leg configured to be fixed directly to a palatine bone, the anchoring leg being affixed or releasably attached to the half of the device body;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of slide rails for guiding a movement of the two halves of the device body, one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body,

wherein—

the anchoring leg has at least one hole configured to guide an implant to be driven through the hole into the palatine bone so as to fix the anchoring leg to the palatine bone, the at least one hole being optionally angled substantially toward the direction of expansion of the M-MARPE device;

the M-MARPE device optionally further comprises a cover that covers all or substantially all the bottom surface of the maxillary skeletal expander device, the cover being releasably attached to the maxillary skeletal expander device; or

two halves of the device body, the two arms, the lock screw, and the pair of slide rails have an antimicrobial surface.

In some embodiments of the device of disclosure, optionally in combination with any of the various embodiments disclosed herein, the device further comprises a cover that covers all or substantially all the bottom surface of the maxillary skeletal expander device, the cover being releasably attached to the maxillary skeletal expander device.

In some embodiments of the device of disclosure, optionally in combination with any of the various embodiments disclosed herein, the two halves of the device body, the two arms, the lock screw, and the pair of slide rails have an antimicrobial surface.

In some embodiments of the device of disclosure, optionally in combination with any of the various embodiments disclosed herein, there is a gap between a top surface of the anchoring leg and a portion of a top surface of the middle portion, which gap is sufficient to allow cleaning, the top surface of the anchoring leg and the top surface of the middle portion are configured to face a palate. In some embodiments, the gap is larger than 1 mm.

In some embodiments of the device of disclosure, optionally in combination with any of the various embodiments disclosed herein, the lock screw comprises a nut configured to be turned by a wrench.

In some embodiments device of disclosure, optionally in combination with any of the various embodiments disclosed herein, each of the pair of slide rails includes a mechanism to prevent a disengagement of the pair of slide rails from the two halves of the device body.

In some embodiments device of disclosure, optionally in combination with any of the various embodiments disclosed herein, the mechanism is a notch and wherein the nut includes a lock strap and wherein the notch accommodates the lock strap.

In some embodiments device of disclosure, optionally in combination with any of the various embodiments disclosed herein, the device comprises four arms, each of the two halves of the device body having two arms attached thereto, one to its left side and the other to its right side.

In some embodiments device of disclosure, optionally in combination with any of the various embodiments disclosed herein, the device comprises two anchoring legs or four anchoring legs,

wherein, when the maxillary skeletal expander device comprises four anchoring legs, each of the two halves of the device body has two anchoring legs attached to the direction of expansion or to its left and right sides, one to its left end and the other to its right end, and

wherein, when the maxillary skeletal expander device comprises two anchoring legs, each of the two halves of the device body has one anchoring leg attached to the direction of expansion.

In some embodiments device of disclosure, optionally in combination with any of the various embodiments disclosed herein, the device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments device of disclosure, optionally in combination with any of the various embodiments disclosed herein, the anchoring leg comprises an opening to allow an implant to be inserted into the palatine bone so as to cause the maxillary skeletal expander to be fixed to the palatine bone.

In some embodiments device of disclosure, optionally in combination with any of the various embodiments disclosed herein, the implant is a screw, a nail.

In some embodiments device of disclosure, optionally in combination with any of the various embodiments disclosed herein, the implant has a cross-section of a circle, a square or a rectangular.

In some embodiments device of disclosure, optionally in combination with any of the various embodiments disclosed herein, the device comprises four arms, wherein the four arms and the slide rails are configured such that:

a first arm having a distal end extending toward teeth, a proximal end slidably coupled to the first body, a portion fixed to the second body, and a slide portion extending from the portion fixed to the second body to the proximal end, the slide portion guiding a movement of the first and second bodies;

a second arm having a distal end extending toward teeth and a proximal end secured to the second body;

a third arm having a distal end extending toward teeth, a proximal end slidably coupled to the second body, a portion fixed to the first body, and a slide portion extending from the portion fixed to the first body to the proximal end, the slide portion guiding a movement of the first and second bodies; and

a fourth arm having a distal end extending toward teeth and a proximal end secured to the first body.

In some embodiments device of disclosure, optionally in combination with any of the various embodiments disclosed herein, a width of the two legs along a direction of the movement of the two halves of the device body being less than a width of the middle portion.

In some embodiments device of disclosure, optionally in combination with any of the various embodiments disclosed herein, the lock screw comprises a nut configured to be rotated by a wrench; and the slide rail comprises a notch that accommodates the nut to prevent a disengagement of the slide rail from the one or both halves of the device body.

In some embodiments device of disclosure, optionally in combination with any of the various embodiments disclosed herein, the nut includes a lock strap that prevents a disengagement of the slide rail from the one or both halves of the device body.

In some embodiments device of disclosure, optionally in combination with any of the various embodiments disclosed herein, a cross section of the slide rail has a shape of a rectangle.

In another aspect of the present disclosure, it is provided a method of fabricating a maxillary skeletal expander device, which method comprising:

detecting a maxillary skeletal disorder in a patient;

prescribing a maxillary skeletal expander device of invention to correct the maxillary skeletal disorder in the patient; and

fabricating the M-MARPE device of invention.

In some embodiments of the disclosed method, the device comprises:

two halves of a device body, each half having a left side and a right side, a middle portion, and at least an anchoring leg configured to be fixed directly to a palatine bone, the anchoring leg being affixed or releasably attached to the half of the device body;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of slide rails for guiding a movement of the two halves of the device body, one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body,

wherein—

the anchoring leg has at least one hole configured to guide an implant to be driven through the hole into the palatine bone so as to fix the anchoring leg to the palatine bone, the at least one hole being optionally angled substantially toward the direction of expansion of the M-MARPE device;

the M-MARPE device optionally further comprises a cover that covers all or substantially all the bottom surface of the maxillary skeletal expander device, the cover being releasably attached to the maxillary skeletal expander device; or

two halves of the device body, the two arms, the lock screw, and the pair of slide rails have an antimicrobial surface.

In some embodiments of the disclosed method, optionally in combination with any of the various embodiments disclosed herein, the device further comprises a cover that covers all or substantially all the bottom surface of the maxillary skeletal expander device, the cover being releasably attached to the maxillary skeletal expander device.

In some embodiments of the disclosed method, optionally in combination with any of the various embodiments disclosed herein, the two halves of the device body, the two arms, the lock screw, and the pair of slide rails have an antimicrobial surface.

In some embodiments of the disclosed method, optionally in combination with any of the various embodiments disclosed herein, there is a gap between a top surface of the anchoring leg and a portion of a top surface of the middle portion, which gap is sufficient to allow cleaning, the top surface of the anchoring leg and the top surface of the middle portion are configured to face a palate. In some embodiments, the gap is larger than 1 mm.

In some embodiments of the disclosed method, optionally in combination with any of the various embodiments disclosed herein, the lock screw comprises a nut configured to be turned by a wrench.

In some embodiments invention method, optionally in combination with any of the various embodiments disclosed herein, each of the pair of slide rails includes a mechanism to prevent a disengagement of the pair of slide rails from the two halves of the device body.

In some embodiments invention method, optionally in combination with any of the various embodiments disclosed herein, the mechanism is a notch and wherein the nut includes a lock strap and wherein the notch accommodates the lock strap.

In some embodiments invention method, optionally in combination with any of the various embodiments disclosed herein, the device comprises four arms, each of the two halves of the device body having two arms attached thereto, one to its left side and the other to its right side.

In some embodiments invention method, optionally in combination with any of the various embodiments disclosed herein, the device comprises two anchoring legs or four anchoring legs, wherein, when the maxillary skeletal expander device comprises four anchoring legs, each of the two halves of the device body has two anchoring legs attached to the direction of expansion or to its left and right sides, one to its left end and the other to its right end, and wherein, when the maxillary skeletal expander device comprises two anchoring legs, each of the two halves of the device body has one anchoring leg attached to the direction of expansion.

In some embodiments invention method, optionally in combination with any of the various embodiments disclosed herein, the device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments invention method, optionally in combination with any of the various embodiments disclosed herein, the anchoring leg comprises an opening to allow an implant to be inserted into the palatine bone so as to cause the maxillary skeletal expander to be fixed to the palatine bone.

In some embodiments invention method, optionally in combination with any of the various embodiments disclosed herein, the implant is a screw, a nail.

In some embodiments device of disclosure, optionally in combination with any of the various embodiments disclosed herein, the implant has a cross-section of a circle, a square or a rectangular.

In some embodiments invention method, optionally in combination with any of the various embodiments disclosed herein, the device comprises four arms, wherein the four arms and the slide rails are configured such that:

a first arm having a distal end extending toward teeth, a proximal end slidably coupled to the first body, a portion fixed to the second body, and a slide portion extending from the portion fixed to the second body to the proximal end, the slide portion guiding a movement of the first and second bodies;

a second arm having a distal end extending toward teeth and a proximal end secured to the second body;

a third arm having a distal end extending toward teeth, a proximal end slidably coupled to the second body, a portion fixed to the first body, and a slide portion extending from the portion fixed to the first body to the proximal end, the slide portion guiding a movement of the first and second bodies; and

a fourth arm having a distal end extending toward teeth and a proximal end secured to the first body.

In some embodiments invention method, optionally in combination with any of the various embodiments disclosed herein, a width of the two legs along a direction of the movement of the two halves of the device body being less than a width of the middle portion.

In some embodiments invention method, optionally in combination with any of the various embodiments disclosed herein, the lock screw comprises a nut configured to be rotated by a wrench; and the slide rail comprises a notch that accommodates the nut to prevent a disengagement of the slide rail from the one or both halves of the device body.

In some embodiments invention method, optionally in combination with any of the various embodiments disclosed herein, the nut includes a lock strap that prevents a disengagement of the slide rail from the one or both halves of the device body.

In some embodiments invention method, optionally in combination with any of the various embodiments disclosed herein, a cross section of the slide rail has a shape of a rectangle.

In some embodiments of the disclosed method, optionally in combination with any of the various embodiments disclosed herein, a metallic or non-metallic material (e.g., a biocompatible polymeric material) can be used to form any or all parts of the device.

The anchoring leg can be attached to the RPE body of the maxillary skeletal expander device invention via any established method of attaching or joining a metallic part to another metallic body. Examples of such methods can be, but is not limited to, soldering, welding, or casting of buttons or any other attachment to the RPE.

In another aspect of the present disclosure, it is provided a method of treating a maxillary skeletal disorder, comprising:

detecting a maxillary skeletal disorder in a patient;

prescribing a maxillary skeletal expander (M-MARPE″) device of invention to correct the maxillary skeletal disorder in the patient;

providing the M-MARPE device of invention;

applying the M-MARPE device of invention to the patient; and periodically adjusting the M-MARPE device by turning the lock screw on the device until a desired result of maxillary skeletal expansion is achieved.

In some embodiments of the disclosed method, the device comprises:

two halves of a device body, each half having a left side and a right side, a middle portion, and at least an anchoring leg configured to be fixed directly to a palatine bone, the anchoring leg being affixed or releasably attached to the half of the device body;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of slide rails for guiding a movement of the two halves of the device body, one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body,

wherein—

the anchoring leg has at least one hole configured to guide an implant to be driven through the hole into the palatine bone so as to fix the anchoring leg to the palatine bone, the at least one hole being optionally angled substantially toward the direction of expansion of the M-MARPE device;

the M-MARPE device optionally further comprises a cover that covers all or substantially all the bottom surface of the maxillary skeletal expander device, the cover being releasably attached to the maxillary skeletal expander device; or

two halves of the device body, the two arms, the lock screw, and the pair of slide rails have an antimicrobial surface.

In some embodiments of the disclosed method, optionally in combination with any of the various embodiments disclosed herein, the device further comprises a cover that covers all or substantially all the bottom surface of the maxillary skeletal expander device, the cover being releasably attached to the maxillary skeletal expander device.

In some embodiments of the disclosed method, optionally in combination with any of the various embodiments disclosed herein, the two halves of the device body, the two arms, the lock screw, and the pair of slide rails have an antimicrobial surface.

In some embodiments of the disclosed method, optionally in combination with any of the various embodiments disclosed herein, there is a gap between a top surface of the anchoring leg and a portion of a top surface of the middle portion, which gap is sufficient to allow cleaning, the top surface of the anchoring leg and the top surface of the middle portion are configured to face a palate. In some embodiments, the gap is larger than 1 mm.

In some embodiments of the disclosed method, optionally in combination with any of the various embodiments disclosed herein, the lock screw comprises a nut configured to be turned by a wrench.

In some embodiments invention method, optionally in combination with any of the various embodiments disclosed herein, each of the pair of slide rails includes a mechanism to prevent a disengagement of the pair of slide rails from the two halves of the device body.

In some embodiments invention method, optionally in combination with any of the various embodiments disclosed herein, the mechanism is a notch and wherein the nut includes a lock strap and wherein the notch accommodates the lock strap.

In some embodiments invention method, optionally in combination with any of the various embodiments disclosed herein, the device comprises four arms, each of the two halves of the device body having two arms attached thereto, one to its left side and the other to its right side.

In some embodiments invention method, optionally in combination with any of the various embodiments disclosed herein, the device comprises two anchoring legs or four anchoring legs,

wherein, when the M-MARPE device comprises four anchoring legs, each of the two halves of the device body has two anchoring legs attached to the direction of expansion or to its left and right sides, one to its left end and the other to its right end, and

wherein, when the M-MARPE device comprises two anchoring legs, each of the two halves of the device body has one anchoring leg attached to the direction of expansion.

In some embodiments invention method, optionally in combination with any of the various embodiments disclosed herein, the device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments invention method, optionally in combination with any of the various embodiments disclosed herein, the anchoring leg comprises an opening to allow an implant to be inserted into the palatine bone so as to cause the maxillary skeletal expander to be fixed to the palatine bone.

In some embodiments invention method, optionally in combination with any of the various embodiments disclosed herein, the implant is a screw, a nail.

In some embodiments device of disclosure, optionally in combination with any of the various embodiments disclosed herein, the implant has a cross-section of a circle, a square or a rectangular.

In some embodiments invention method, optionally in combination with any of the various embodiments disclosed herein, the device comprises four arms, wherein the four arms and the slide rails are configured such that:

a first arm having a distal end extending toward teeth, a proximal end slidably coupled to the first body, a portion fixed to the second body, and a slide portion extending from the portion fixed to the second body to the proximal end, the slide portion guiding a movement of the first and second bodies;

a second arm having a distal end extending toward teeth and a proximal end secured to the second body;

a third arm having a distal end extending toward teeth, a proximal end slidably coupled to the second body, a portion fixed to the first body, and a slide portion extending from the portion fixed to the first body to the proximal end, the slide portion guiding a movement of the first and second bodies; and

a fourth arm having a distal end extending toward teeth and a proximal end secured to the first body.

In some embodiments invention method, optionally in combination with any of the various embodiments disclosed herein, a width of the two legs along a direction of the movement of the two halves of the device body being less than a width of the middle portion.

In some embodiments invention method, optionally in combination with any of the various embodiments disclosed herein, the lock screw comprises a nut configured to be rotated by a wrench; and the slide rail comprises a notch that accommodates the nut to prevent a disengagement of the slide rail from the one or both halves of the device body.

In some embodiments invention method, optionally in combination with any of the various embodiments disclosed herein, the nut includes a lock strap that prevents a disengagement of the slide rail from the one or both halves of the device body.

In some embodiments invention method, optionally in combination with any of the various embodiments disclosed herein, a cross section of the slide rail has a shape of a rectangle.

In some embodiments of the disclosed method, optionally in combination with any of the various embodiments disclosed herein, a metallic or non-metallic material (e.g., a biocompatible polymeric material) can be used to form any or all parts of the device.

### BRIEF DESCRIPTION OF THE DRAWINGS

FIG. 1 shows an embodiment of the invention M-MARPE device.

FIG. 2 shows an expanded view of an embodiment of the lock screw 300 and guide rails 400 of an embodiment of the device of disclosure.

FIG. 3 shows a side view of one of the two halves 100 of an embodiment of the device of disclosure having two arms 200.

FIG. 3A shows a side view of one of the two halves 100 of an embodiment of the device of disclosure having one arm 200.

FIG. 4 shows a side view of an embodiment of device of disclosure.

FIG. 5 shows a side view of one of the two halves of an embodiment of device of disclosure.

FIG. 6 shows an embodiment of invention M-NARPE device having a cover that covers the two halves of the M-MARPE device.

FIG. 7 illustrates an embodiment of device of disclosure M-MARPE having an antimicrobial surface.

FIG. 8 illustrates an embodiment of device of disclosure M-MARPE where the anchoring legs are positioned in the direction of expansion of device of disclosure M-MARPE.

FIG. 9 illustrates a further embodiment of device of disclosure M-MARPE where the anchoring legs are positioned in the direction of expansion of device of disclosure M-MARPE.

FIG. 10 illustrates an embodiment of device of disclosure M-MARPE where a tooth fixing part is attached to a tooth, the fixing part being attached to the distal end of one of the four arms.

### DETAILED DESCRIPTION OF THE INVENTION

U.S. application Ser. No. 15/680,036 describes a maxillary skeletal expander device (M-MARPE) that overcomes the shortcomings of the MARPE device described in U.S. Pat. No. 9,351,810, while improving the efficiency of expanding the palatal area for both young and adult patients and drastically minimizing the potential for oral health related complications. There are several key differences between the M-MARPE and the MARPE, and differences are the advantageous features of the M-MARPE device over the MARPE device. Rather than creating holes directly on the peripheral of the body of the RPE as the MARPE does, the M-MARPE utilizes auxiliary attachments that are welded, or soldered, on to the RPE, and these auxiliary attachments are configured to maintain close physical contact with the palatal region. These attachments serve critical functions that greatly enhance the way in which the palatal region is expanded. First, the fact that the attachments maintain physical contact with the palatal region at all times allows for greater accuracy during the micro-implant implantation process because the holes in the attachments guide, or funnel, the micro-implants all the way to the desired anchorage location with precision. Second, because there is no gap between the attachments and the micro-implants, the potential for food debris to get lodged between the screw and the appliance is eliminated. This greatly reduces the likelihood of the development of foul mouth odor and poor oral hygiene in patients. Third, because the micro-implants are completely covered, or sheathed, in the attachments, they are protected from disturbances by foreign objects, thereby greatly reducing the potential for the micro-implants to become dislodged from the palatal region.

As used herein, the term “top surface” of an anchoring leg refers to the surface of the anchoring leg contacting the palatal surface of the oral cavity.

As used herein, the term “direction of expansion” or “expansion direction” are used interchangeably and refers to the direction of an expansion force of the expander device toward the buccal sides generated by turning of the lock screw of the device of disclosure. As is guided by the guide rails, the direction of expansion of the device of disclosure must be in the body plane of the expander device and in the direction of the guide rails.

As used herein, the term “angled” refers to having a hole for an implant on an anchoring leg that is not perpendicular to the body plane of the expander device of invention. In this context, the term “substantially toward” refers to an angle that is directed outward toward a buccal side such that the hole would have an angle with the body plane of the expander device less than 90 degree but more than 0 degree, e.g., an angle of about 10-80 degree, about 20-70 degree, about 30-60 degree, about 40-50 degree, or about 45 degree.

Therefore, in one aspect of the present disclosure, it is provided a maxillary skeletal expander device, it is provided a maxillary skeletal expander device, comprising:

two halves of a device body, each half having a left side and a right side, a middle portion, and at least an anchoring leg configured to be fixed directly to a palatine bone, the anchoring leg being affixed or releasably attached to the half of the device body;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of slide rails for guiding a movement of the two halves of the device body, one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body,

wherein—

the anchoring leg has at least one hole configured to guide an implant to be driven through the hole into the palatine bone so as to fix the anchoring leg to the palatine bone, the at least one hole being optionally angled substantially toward the direction of expansion of the M-MARPE device;

the M-MARPE device optionally further comprises a cover that covers all or substantially all the bottom surface of the maxillary skeletal expander device, the cover being releasably attached to the M-MARPE device; or

two halves of the device body, the two arms, the lock screw, and the pair of slide rails have an antimicrobial surface.

In some embodiments of the device of disclosure, optionally in combination with any of the various embodiments disclosed herein, the device further comprises a cover that covers all or substantially all the bottom surface of the maxillary skeletal expander device, the cover being releasably attached to the maxillary skeletal expander device.

In some embodiments of the device of disclosure, optionally in combination with any of the various embodiments disclosed herein, the two halves of the device body, the two arms, the lock screw, and the pair of slide rails have an antimicrobial surface.

In some embodiments of the device of disclosure, optionally in combination with any of the various embodiments disclosed herein, there is a gap between a top surface of the anchoring leg and a portion of a top surface of the middle portion, which gap is sufficient to allow cleaning, the top surface of the anchoring leg and the top surface of the middle portion are configured to face a palate. In some embodiments, the gap is larger than 1 mm.

In some embodiments of the device of disclosure, optionally in combination with any of the various embodiments disclosed herein, the lock screw comprises a nut configured to be turned by a wrench.

In some embodiments device of disclosure, optionally in combination with any of the various embodiments disclosed herein, each of the pair of slide rails includes a mechanism to prevent a disengagement of the pair of slide rails from the two halves of the device body.

In some embodiments device of disclosure, optionally in combination with any of the various embodiments disclosed herein, the mechanism is a notch and wherein the nut includes a lock strap and wherein the notch accommodates the lock strap.

In some embodiments device of disclosure, optionally in combination with any of the various embodiments disclosed herein, the device comprises four arms, each of the two halves of the device body having two arms attached thereto, one to its left side and the other to its right side.

In some embodiments device of disclosure, optionally in combination with any of the various embodiments disclosed herein, the device comprises two anchoring legs or four anchoring legs,

wherein, when the maxillary skeletal expander device comprises four anchoring legs, each of the two halves of the device body has two anchoring legs attached to the direction of expansion or to its left and right sides, one to its left end and the other to its right end, and

wherein, when the maxillary skeletal expander device comprises two anchoring legs, each of the two halves of the device body has one anchoring leg attached to the direction of expansion.

In some embodiments device of disclosure, optionally in combination with any of the various embodiments disclosed herein, the device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments device of disclosure, optionally in combination with any of the various embodiments disclosed herein, the anchoring leg comprises an opening to allow an implant to be inserted into the palatine bone so as to cause the maxillary skeletal expander to be fixed to the palatine bone.

In some embodiments device of disclosure, optionally in combination with any of the various embodiments disclosed herein, the implant is a screw, a nail.

In some embodiments device of disclosure, optionally in combination with any of the various embodiments disclosed herein, the implant has a cross-section of a circle, a square or a rectangular.

In some embodiments device of disclosure, optionally in combination with any of the various embodiments disclosed herein, the device comprises four arms, wherein the four arms and the slide rails are configured such that:

a first arm having a distal end extending toward teeth, a proximal end slidably coupled to the first body, a portion fixed to the second body, and a slide portion extending from the portion fixed to the second body to the proximal end, the slide portion guiding a movement of the first and second bodies;

a second arm having a distal end extending toward teeth and a proximal end secured to the second body;

a third arm having a distal end extending toward teeth, a proximal end slidably coupled to the second body, a portion fixed to the first body, and a slide portion extending from the portion fixed to the first body to the proximal end, the slide portion guiding a movement of the first and second bodies; and

a fourth arm having a distal end extending toward teeth and a proximal end secured to the first body.

In some embodiments device of disclosure, optionally in combination with any of the various embodiments disclosed herein, a width of the two legs along a direction of the movement of the two halves of the device body being less than a width of the middle portion.

In some embodiments device of disclosure, optionally in combination with any of the various embodiments disclosed herein, the lock screw comprises a nut configured to be rotated by a wrench; and the slide rail comprises a notch that accommodates the nut to prevent a disengagement of the slide rail from the one or both halves of the device body.

In some embodiments device of disclosure, optionally in combination with any of the various embodiments disclosed herein, the nut includes a lock strap that prevents a disengagement of the slide rail from the one or both halves of the device body.

In some embodiments device of disclosure, optionally in combination with any of the various embodiments disclosed herein, a cross section of the slide rail has a shape of a rectangle.

The teaching of U.S. Pat. No. 9,351,810 is incorporated herein in its entirety.

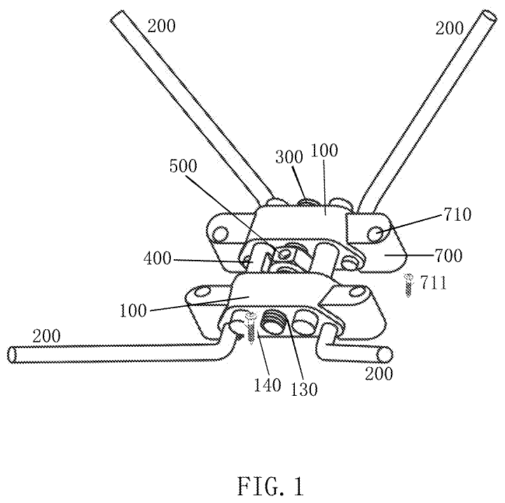

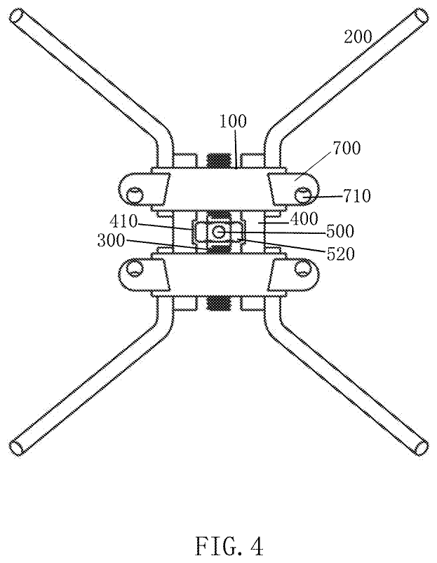

FIGS. 1-5 describe a few embodiments of the device of disclosure. In FIG. 1, an embodiment of the invention M-MARPE device is shown, viewed from the palatal bone contact surface, to have two halves 100, four arms 200, a lock screw 300 built with a turning key hole 500, two guide rails 400, four anchoring legs 700, each with an implant 711 and an implant insertion opening 710 that has an angle. A tongue-facing side to palatine bone-facing side view of the angled implant insertion opening 710 is clearly shown by partial eclipsing of the palatine bone-facing opening in FIG. 4.

It is noteworthy that arm 200, which is directed out-upward toward a tooth/teeth, an implant to insert into the palatine bone of a patient/subject through an angled opening 710 directed out-downward, and an outward expansion force through screw 300 form a tripod like force configuration so as to maximize the anchoring of the expansion force and its efficacy on maxillary skeletal expansion.

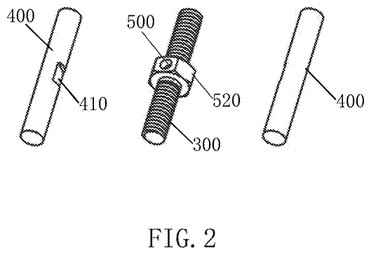

An expanded view of an embodiment of the lock screw 300 and guide rails 400 is shown in FIG. 2, where the lock screw is shown to include a nut 520 on which the turning key hole 500 is built. In some embodiments, the nut 520 can be configured to allow the lock screw 300 to be turned using a wrench. Guide rails 400 are shown to include a notch 410 to accommodate nut 520 on lock screw 300.

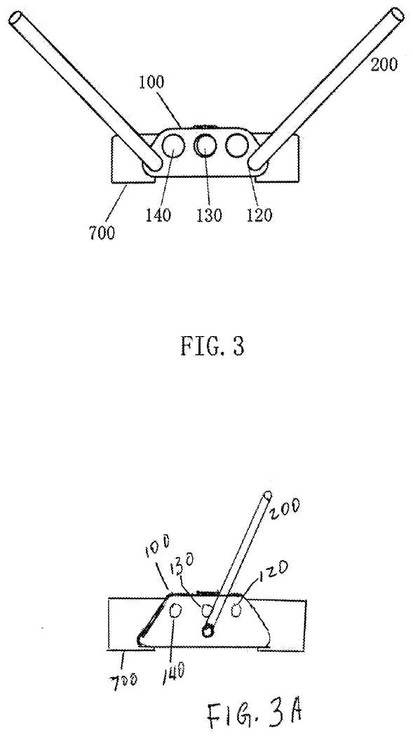

FIG. 3 shows a side view of one of the two halves 100 of an embodiment of the device of disclosure, showing two arms 200, attachment point or insertion point 120 for arm 200, lock screw hole 130 to receive one end of the lock screw 300, a pair of holes 140 to receive guide rails 400, and two anchoring legs 700.

FIG. 3A shows a side view of one of the two halves 100 of an embodiment of the device of disclosure, showing a single arm 200, attachment point or insertion point 120 for arm 200, lock screw hole 130 to receive one end of the lock screw 300, a pair of holes 140 to receive guide rails 400, and two anchoring legs 700.

A side view of an embodiment of device of disclosure is shown in FIG. 4, viewed from the surface away from the palatal bone, showing that the device includes two halves 100, four arms 200, a lock screw 300 with a turning hole 500 on a nut 520, two guide rails 400 with a notch to accommodate nut 520, four anchoring legs 700, each with an opening 710 for implant insertion. The opening 710 being angled toward the direction of expansion of the device as the tongue-facing side to palatine bone-facing side view of the angled implant insertion opening 710 clearly shows eclipsing of the palatine bone-facing opening.

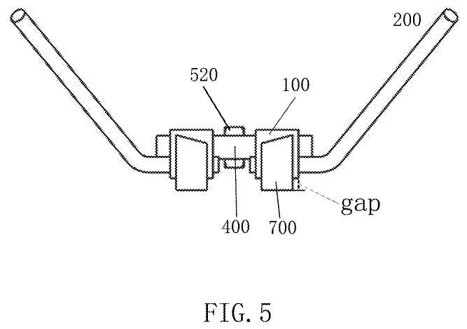

FIG. 5 shows a side view of one of the two halves of an embodiment of device of disclosure, showing one halve of the device body 100, two arms 200, a nut 520 on lock screw 300 (not shown), a guide rail 400, and two anchoring legs 700 where the surface of the anchoring leg in contact with the palatal bone and the surface of the two halves 100 of the device body facing the palatal bone are shown to have a gap in height.

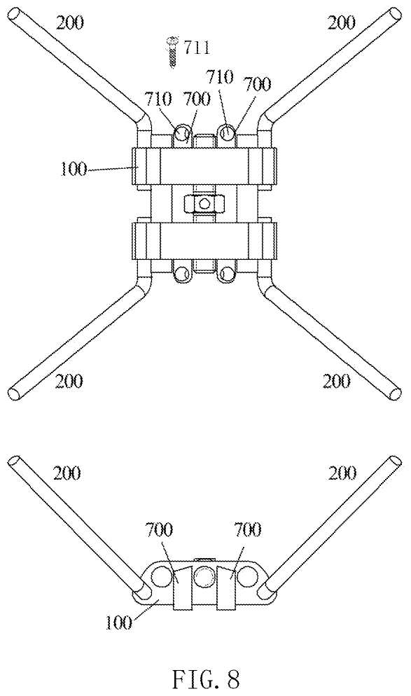

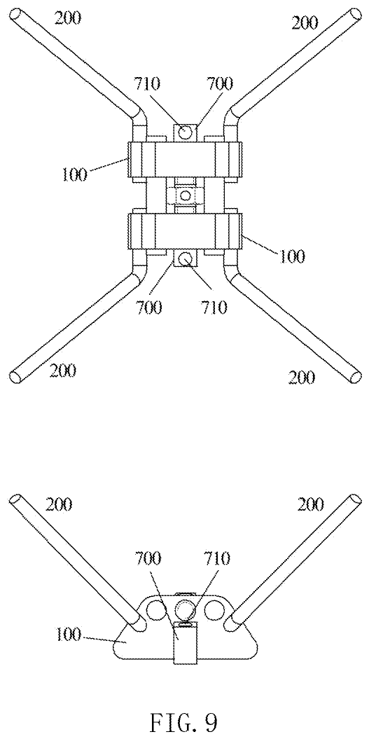

FIGS. 8 and 9 describe embodiments of the device of disclosure where the anchoring legs are positioned in the direction of the expansion of the device of disclosure. In FIG. 8, an embodiment of the invention M-MARPE device is shown, each viewed from the tongue facing surface, to have two halves 100, four arms 200, four anchoring legs 700, each with an implant 711 with an insertion opening 710 that has an angle. The lock screw built with a turning key hole are shown but not described, and two guide rails which are not shown. In FIG. 9, an embodiment of the invention M-MARPE device is shown, viewed from the tongue facing surface, to have two halves 100, four arms 200, two anchoring legs 700, each with an implant insertion opening 710 that has an angle. The lock screw built with a turning key hole and two guide rails, which are shown but not provided with a numbering label.

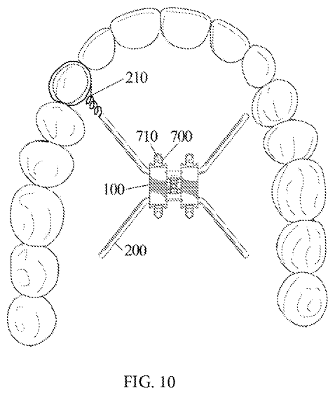

FIG. 10 shows an embodiment of the invention M-MARPE device, viewed from the tongue facing surface, where a tooth fixing part 210 is secured to a tooth, the tooth fixing part being secured to an arm 200, which is attached to one half of the device of disclosure, 100, the one half having two arms 200, anchoring legs 700 having an implant insertion hole 710. For concise description, implant 711 is omitted.

Cover

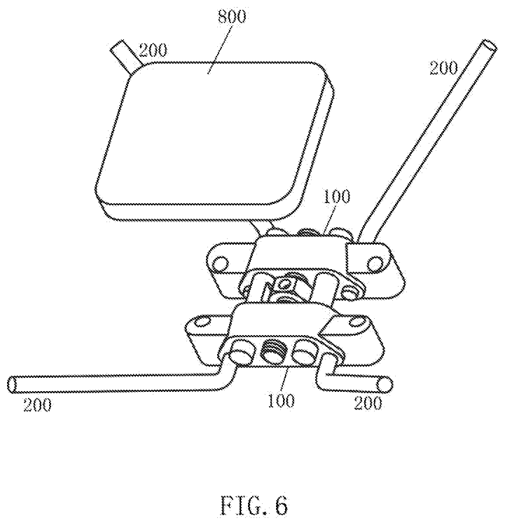

A cover as described herein provides for coverage or enclosure of the body of device of disclosure to prevent it from being exposed, e.g., to tongue or food or drinks (see FIG. 6). The cover can be made from any biocompatible material, e.g., a metallic material or a plastic material. In some embodiments, the cover can have a mechanism for it to releaseably attach to the device body. Such as mechanism can be, for example, a lock or interlock, which can be readily designed and fabricated by a person of ordinary skill in the art. FIG. 6 shows an embodiment of the invention M-NARPE device having a cover 800 that covers the two halves of the M-MARPE device on the tongue facing surface of the device.

Antimicrobial Surface

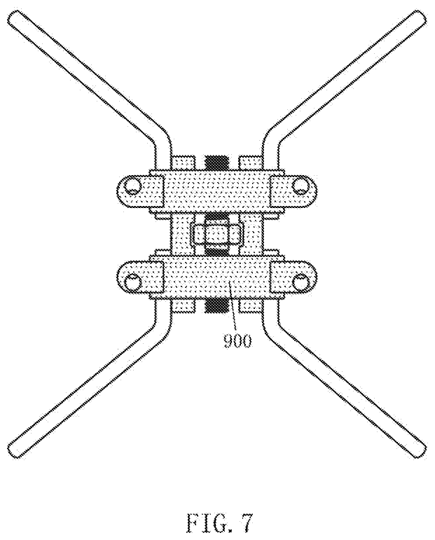

In some embodiments, surface of the device of disclosure can be modified to include an antimicrobial surface. Method of generating an antimicrobial surface on a metallic device is known in the art, which can be, for example, forming an antimicrobial coating on the device. The antimicrobial coating can include an antimicrobial agent, with or without a polymer. The antimicrobial agent can be an antimicrobial drug. In some embodiments, the antimicrobial agent can be silver nanoparticles. FIG. 7 depicts such antimicrobial surface on a device of invention where an antimicrobial surface 900 is formed onto the entire surface of the device of disclosure, viewed from surface facing the palatal bone. Note, alternatively, the antimicrobial surface can cover only a portion of the surface of the device of disclosure.

As used herein, the term “antimicrobial surface” does not include any surface area or any part of an implant of the device of disclosure. In this context, the antimicrobial coating also does not include involve any surface area of part of the implant of the device of disclosure.

Some examples of antimicrobial agent useful herein includes Ag nanoparticle-TiO2 composite, Ag nanoparticle-polyacrylate hydrogel, Ag nanoparticles with chitosan as a coating, Au nanoparticles, Au nanoparticles and cefaclor in apatite coating, cobalt in resin/polymer, Cu oxide nanocomposites with polyurethane, Cu in diamond-like carbon film, Cu in resin/polymer, ZnO coating, Zn in resin, Zr in resin, BiN₃O₉, C₆H₉BiO₆ coating, Se in hydroxyapatite coating, Mo in resin, chlorohexidine (CHX) digluconate, chlorohexidine digluconate in chitosan coating, chlorohexidine digluconate in polymer coating, fluoridated calcium phosphate coating, polyhexanide, guanidine/2-aminoethyl-methcrylate polymer, Tobramycin (TOB), Vancomycin (VAN), Gentamicin (GEN), Tetracycline (TET), Nystatin (NYT), and combinations of any of these. As used herein, the term resin can be used interchangeably with the term polymer.

Unless specified, an antimicrobial agent here can be used to form a coating on the device of disclosure with or without a polymer, which can be synthetic polymer or natural polymer such as chitosan.

Methods of Fabrication

In another aspect of the present disclosure, it is provided a method of fabrication of a maxillary skeletal expander (“M-MARPE”) device, which method comprising:

detecting a maxillary skeletal disorder in a patient;

prescribing a maxillary skeletal expander device of invention to correct the maxillary skeletal disorder in the patient; and

fabricating the M-MARPE device of invention.

In some embodiments of the disclosed method, the device comprises:

two halves of a device body, each half having a left side and a right side, a middle portion, and at least an anchoring leg configured to be fixed directly to a palatine bone, the anchoring leg being affixed or releasably attached to the half of the device body;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of slide rails for guiding a movement of the two halves of the device body, one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body,

wherein—

the anchoring leg has at least one hole configured to guide an implant to be driven through the hole into the palatine bone so as to fix the anchoring leg to the palatine bone, the at least one hole being optionally angled substantially toward the direction of expansion of the M-MARPE device;

the M-MARPE device optionally further comprises a cover that covers all or substantially all the bottom surface of the maxillary skeletal expander device, the cover being releasably attached to the M-MARPE device; or

two halves of the device body, the two arms, the lock screw, and the pair of slide rails have an antimicrobial surface.

In some embodiments of the disclosed method, optionally in combination with any of the various embodiments disclosed herein, the device further comprises a cover that covers all or substantially all the bottom surface of the maxillary skeletal expander device, the cover being releasably attached to the maxillary skeletal expander device.

In some embodiments of the disclosed method, optionally in combination with any of the various embodiments disclosed herein, the two halves of the device body, the two arms, the lock screw, and the pair of slide rails have an antimicrobial surface.

In some embodiments of the disclosed method, optionally in combination with any of the various embodiments disclosed herein, there is a gap between a top surface of the anchoring leg and a portion of a top surface of the middle portion, which gap is sufficient to allow cleaning, the top surface of the anchoring leg and the top surface of the middle portion are configured to face a palate. In some embodiments, the gap is larger than 1 mm.

In some embodiments of the disclosed method, optionally in combination with any of the various embodiments disclosed herein, the lock screw comprises a nut configured to be turned by a wrench.

In some embodiments invention method, optionally in combination with any of the various embodiments disclosed herein, each of the pair of slide rails includes a mechanism to prevent a disengagement of the pair of slide rails from the two halves of the device body.

In some embodiments invention method, optionally in combination with any of the various embodiments disclosed herein, the mechanism is a notch and wherein the nut includes a lock strap and wherein the notch accommodates the lock strap.

In some embodiments invention method, optionally in combination with any of the various embodiments disclosed herein, the device comprises four arms, each of the two halves of the device body having two arms attached thereto, one to its left side and the other to its right side.

In some embodiments invention method, optionally in combination with any of the various embodiments disclosed herein, the device comprises two anchoring legs or four anchoring legs,

wherein, when the maxillary skeletal expander device comprises four anchoring legs, each of the two halves of the device body has two anchoring legs attached to the direction of expansion or to its left and right sides, one to its left end and the other to its right end, and

wherein, when the maxillary skeletal expander device comprises two anchoring legs, each of the two halves of the device body has one anchoring leg attached to the direction of expansion.

In some embodiments invention method, optionally in combination with any of the various embodiments disclosed herein, the device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments invention method, optionally in combination with any of the various embodiments disclosed herein, the anchoring leg comprises an opening to allow an implant to be inserted into the palatine bone so as to cause the maxillary skeletal expander to be fixed to the palatine bone.

In some embodiments invention method, optionally in combination with any of the various embodiments disclosed herein, the implant is a screw, a nail.

In some embodiments device of disclosure, optionally in combination with any of the various embodiments disclosed herein, the implant has a cross-section of a circle, a square or a rectangular.

In some embodiments invention method, optionally in combination with any of the various embodiments disclosed herein, the device comprises four arms, wherein the four arms and the slide rails are configured such that:

a first arm having a distal end extending toward teeth, a proximal end slidably coupled to the first body, a portion fixed to the second body, and a slide portion extending from the portion fixed to the second body to the proximal end, the slide portion guiding a movement of the first and second bodies;

a second arm having a distal end extending toward teeth and a proximal end secured to the second body;

a third arm having a distal end extending toward teeth, a proximal end slidably coupled to the second body, a portion fixed to the first body, and a slide portion extending from the portion fixed to the first body to the proximal end, the slide portion guiding a movement of the first and second bodies; and

a fourth arm having a distal end extending toward teeth and a proximal end secured to the first body.

In some embodiments invention method, optionally in combination with any of the various embodiments disclosed herein, a width of the two legs along a direction of the movement of the two halves of the device body being less than a width of the middle portion.

In some embodiments invention method, optionally in combination with any of the various embodiments disclosed herein, the lock screw comprises a nut configured to be rotated by a wrench; and the slide rail comprises a notch that accommodates the nut to prevent a disengagement of the slide rail from the one or both halves of the device body.

In some embodiments invention method, optionally in combination with any of the various embodiments disclosed herein, the nut includes a lock strap that prevents a disengagement of the slide rail from the one or both halves of the device body.

In some embodiments invention method, optionally in combination with any of the various embodiments disclosed herein, a cross section of the slide rail has a shape of a rectangle.

In some embodiments of the disclosed method, optionally in combination with any of the various embodiments disclosed herein, a metallic or non-metallic material (e.g., a biocompatible polymeric material) can be used to form any or all parts of the device.

The maxillary skeletal expander device of invention can be made from any biocompatible material having suitable mechanical strength as a maxillary skeletal expander device. Such material can be a metallic material or non-metallic material or both. Such biocompatible materials are well documented in the biomedical field, which include, for example, metallic materials such as titanium, zirconium, stainless steel, nitinol, aluminum, iron, or an alloy thereof, or in some embodiments, a polymeric material such as polylacic acid or high density polyethylene.

The anchoring leg can be attached to the RPE body of the maxillary skeletal expander device invention via any established method of attaching or joining a metallic part to another metallic body. Examples of such methods can be, but is not limited to, soldering, welding, or casting of buttons or any other attachment to the RPE.

### Method of Use

The device of disclosure can be used to correct a maxillary skeletal disorder in a patient. In another aspect of the present disclosure, it is provided a method of treating a maxillary skeletal disorder, comprising:

detecting a maxillary skeletal disorder in a patient;

prescribing a maxillary skeletal expander device (“M-MARPE”) of invention to correct the maxillary skeletal disorder in the patient;

providing the M-MARPE device of invention;

applying the M-MARPE device of invention to the patient; and periodically adjusting the M-MARPE device by turning the lock screw on the device until a desired result of maxillary skeletal expansion is achieved.

In some embodiments of the disclosed method, the device comprises:

two halves of a device body, each half having a left side and a right side, a middle portion, and at least an anchoring leg configured to be fixed directly to a palatine bone, the anchoring leg being affixed or releasably attached to the half of the device body;

at least two arms, each of the at least two arms having a proximal end fixed to one of the two halves of the device body and a distal end extending toward teeth;

a lock screw rotatably coupled to the two halves of the device body and configured to adjust a distance between the two halves of the device body; and

a pair of slide rails for guiding a movement of the two halves of the device body, one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body,

wherein—

the anchoring leg has at least one hole configured to guide an implant to be driven through the hole into the palatine bone so as to fix the anchoring leg to the palatine bone, the at least one hole being optionally angled substantially toward the direction of expansion of the M-MARPE device;

the M-MARPE device optionally further comprises a cover that covers all or substantially all the bottom surface of the maxillary skeletal expander device, the cover being releasably attached to M-MARPE device; or

two halves of the device body, the two arms, the lock screw, and the pair of slide rails have an antimicrobial surface.

In some embodiments of the disclosed method, optionally in combination with any of the various embodiments disclosed herein, the device further comprises a cover that covers all or substantially all the bottom surface of the maxillary skeletal expander device, the cover being releasably attached to the maxillary skeletal expander device.

In some embodiments of the disclosed method, optionally in combination with any of the various embodiments disclosed herein, the two halves of the device body, the two arms, the lock screw, and the pair of slide rails have an antimicrobial surface.

In some embodiments of the disclosed method, optionally in combination with any of the various embodiments disclosed herein, there is a gap between a top surface of the anchoring leg and a portion of a top surface of the middle portion, which gap is sufficient to allow cleaning, the top surface of the anchoring leg and the top surface of the middle portion are configured to face a palate. In some embodiments, the gap is larger than 1 mm.

In some embodiments of the disclosed method, optionally in combination with any of the various embodiments disclosed herein, the lock screw comprises a nut configured to be turned by a wrench.

In some embodiments invention method, optionally in combination with any of the various embodiments disclosed herein, each of the pair of slide rails includes a mechanism to prevent a disengagement of the pair of slide rails from the two halves of the device body.

In some embodiments invention method, optionally in combination with any of the various embodiments disclosed herein, the mechanism is a notch and wherein the nut includes a lock strap and wherein the notch accommodates the lock strap.

In some embodiments invention method, optionally in combination with any of the various embodiments disclosed herein, the device comprises four arms, each of the two halves of the device body having two arms attached thereto, one to its left side and the other to its right side.

In some embodiments invention method, optionally in combination with any of the various embodiments disclosed herein, the device comprises two anchoring legs or four anchoring legs,

wherein, when the maxillary skeletal expander device comprises four anchoring legs, each of the two halves of the device body has two anchoring legs attached to the direction of expansion or to its left and right sides, one to its left end and the other to its right end, and

wherein, when the maxillary skeletal expander device comprises two anchoring legs, each of the two halves of the device body has one anchoring leg attached to the direction of expansion.

In some embodiments invention method, optionally in combination with any of the various embodiments disclosed herein, the device further comprises:

a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments invention method, optionally in combination with any of the various embodiments disclosed herein, the anchoring leg comprises an opening to allow an implant to be inserted into the palatine bone so as to cause the maxillary skeletal expander to be fixed to the palatine bone.

In some embodiments invention method, optionally in combination with any of the various embodiments disclosed herein, the implant is a screw, a nail.

In some embodiments device of disclosure, optionally in combination with any of the various embodiments disclosed herein, the implant has a cross-section of a circle, a square or a rectangular.

In some embodiments invention method, optionally in combination with any of the various embodiments disclosed herein, the device comprises four arms, wherein the four arms and the slide rails are configured such that:

a first arm having a distal end extending toward teeth, a proximal end slidably coupled to the first body, a portion fixed to the second body, and a slide portion extending from the portion fixed to the second body to the proximal end, the slide portion guiding a movement of the first and second bodies;

a second arm having a distal end extending toward teeth and a proximal end secured to the second body;

a third arm having a distal end extending toward teeth, a proximal end slidably coupled to the second body, a portion fixed to the first body, and a slide portion extending from the portion fixed to the first body to the proximal end, the slide portion guiding a movement of the first and second bodies; and

a fourth arm having a distal end extending toward teeth and a proximal end secured to the first body.

In some embodiments invention method, optionally in combination with any of the various embodiments disclosed herein, a width of the two legs along a direction of the movement of the two halves of the device body being less than a width of the middle portion.

In some embodiments invention method, optionally in combination with any of the various embodiments disclosed herein, the lock screw comprises a nut configured to be rotated by a wrench; and the slide rail comprises a notch that accommodates the nut to prevent a disengagement of the slide rail from the one or both halves of the device body.

In some embodiments invention method, optionally in combination with any of the various embodiments disclosed herein, the nut includes a lock strap that prevents a disengagement of the slide rail from the one or both halves of the device body.

In some embodiments invention method, optionally in combination with any of the various embodiments disclosed herein, a cross section of the slide rail has a shape of a rectangle.

Those skilled in the art will know, or be able to ascertain, using no more than routine experimentation, many equivalents to the specific embodiments of the invention described herein. These and all other equivalents are intended to be encompassed by the following claims.

We claim:

1. A maxillary skeletal expander (“M-MARPE”) device, comprising:
two halves of a device body, each half having a left side and a right side, a middle portion, and at least an anchoring leg configured to be fixed directly to a palatine bone, the anchoring leg being affixed or releasably attached to the half of the device body;
at least two arms, each of the at least two arms having a proximal end fixed to one of the two halves of the device body and a distal end extending toward teeth;
a lock screw rotatably coupled to the two halves of the device body and configured to adjust a distance between the two halves of the device body; and
a pair of slide rails for guiding a movement of the two halves of the device body, one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body,
wherein—
the anchoring leg has at least one hole configured to guide an implant to be driven through the hole into the palatine bone so as to fix the anchoring leg to the palatine bone, the at least one hole being optionally angled substantially toward the direction of expansion of the M-MARPE device;
the M-MARPE device optionally further comprises a cover that covers all or substantially all the bottom surface of the maxillary skeletal expander device, the cover being releasably attached to the maxillary skeletal expander device; or
two halves of the device body, the two arms, the lock screw, and the pair of slide rails have an antimicrobial surface comprising a antimicrobial agent selected from the group consisting of Ag nanoparticle-TiO2 composite, Ag nanoparticle-polyacrylate hydrogel, Ag nanoparticles with chitosan as a coating, Au nanoparticles, Au nanoparticles and cefaclor in apatite coating, cobalt in resin/polymer, Cu oxide nanocomposites with polyurethane, Cu in diamond-like carbon film, Cu in resin/polymer, ZnO coating, Zn in resin, Zr in resin, BiN₃O₉, C₆H₉BiO₆ coating, Se in hydroxyapatite coating, Mo in resin, chlorohexidine (CHX) digluconate, chlorohexidine digluconate in chitosan coating, chlorohexidine digluconate in polymer coating, fluoridated calcium phosphate coating, polyhexanide, guanidine/2-aminoethyl-methcrylate polymer, Tobramycin (TOB), Vancomycin (VAN), Gentamicin (GEN), Tetracycline (JET), Nystatin (NYT), and combinations of any of these.

2. The M-MARPE device of claim 1, comprising a cover that covers all or substantially all the bottom surface of the maxillary skeletal expander device, the cover being releasably attached to the maxillary skeletal expander device.

3. The maxillary skeletal expander device according to claim 1, comprising four arms, each of the two halves of the device body having two arms attached thereto, one to its left side and the other to its right side.

4. The maxillary skeletal expander device according to claim 1, comprising four anchoring legs,
wherein each of the two halves of the device body has two anchoring legs attached to the direction of expansion or to its left and right sides, one to its left end and the other to its right end.

5. The M-MARPE device of claim 4, further comprising:
a pair of teeth fixing parts, the distal end of each arm attached to one halve of the device body being secured to one of the pair of teeth fixing parts, and the distal end of each arm attached to the other halve of the device body being secured to the other of the teeth fixing parts.

6. The maxillary skeletal expander device according to claim 1, wherein the implant is a screw or a nail.

7. A method of fabricating a maxillary skeletal expander (“M-MARPE”) device, comprising:
detecting a maxillary skeletal disorder in a patient;
prescribing a M-MARPE device to correct the maxillary skeletal disorder in the patient;
fabricating the M-MARPE device; and
applying the M-MARPE device to the patient; and periodically adjusting the M-MARPE device by turning a lock screw on the device until a desired result of maxillary skeletal expansion is achieved, the M-MARPE comprising:
two halves of a device body, each half having a left side and a right side, a middle portion, and at least an anchoring leg configured to be fixed directly to a palatine bone, the anchoring leg being affixed or releasably attached to the half of the device body;
at least two arms, each of the at least two arms having a proximal end fixed to one of the two halves of the device body and a distal end extending toward teeth;
a lock screw rotatably coupled to the two halves of the device body and configured to adjust a distance between the two halves of the device body; and
a pair of slide rails for guiding a movement of the two halves of the device body, one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body,
wherein—
the anchoring leg has at least one hole configured to guide an implant to be driven through the hole into the palatine bone so as to fix the anchoring leg to the palatine bone, the at least one hole being optionally angled substantially toward the direction of expansion of the M-MARPE device;
the M-MARPE device optionally further comprises a cover that covers all or substantially all the bottom surface of the M-MARPE device, the cover being releasably attached to the maxillary skeletal expander device; or
two halves of the device body, the two arms, the lock screw, and the pair of slide rails have an antimicrobial surface comprising a antimicrobial agent selected from the group consisting of Ag nanoparticle-TiO2 composite, Ag nanoparticle-polyacrylate hydrogel, Ag nanoparticles with chitosan as a coating, Au nanoparticles, Au nanoparticles and cefaclor in apatite coating, cobalt in resin/polymer, Cu oxide nanocomposites with polyurethane, Cu in diamond-like carbon film, Cu in resin/polymer, ZnO coating, Zn in resin, Zr in resin, BiN₃O₉, C₆H₉BiO₆ coating, Se in hydroxyapatite coating, Mo in resin, chlorohexidine (CHX) digluconate, chlorohexidine digluconate in chitosan coating, chlorohexidine digluconate in polymer coating, fluoridated calcium phosphate coating, polyhexanide, guanidine/2-aminoethyl-methcrylate polymer, Tobramycin (TOB), Vancomycin (VAN), Gentamicin (GEN) Tetracycline (TET), Nystatin (NYT), and combinations of any of these.

8. The method of claim 7, wherein fabricating comprises attaching an anchoring leg to each of the two halves of the device body.

9. The method of claim 7, wherein the M-MARPE comprises a cover that covers all or substantially all the bottom surface of the maxillary skeletal expander device, the cover being releasably attached to the maxillary skeletal expander device.

10. The method of claim 7, wherein the M-MARPE comprises four arms, each of the two halves of the device body having two arms attached thereto, one to its left side and the other to its right side.

11. The method of claim 7, wherein the M-MARPE comprises four anchoring legs, wherein each of the two halves of the device body has two anchoring legs attached to the direction of expansion or to its left and right sides, one to its left end and the other to its right end.

12. The method of claim 7, wherein the M-MARPE further comprises:
a pair of teeth fixing parts, the distal end of each arm attached to one halve of the device body being secured to one of the pair of teeth fixing parts, and the distal end of each arm attached to the other halve of the device body being secured to the other of the teeth fixing parts.

13. The method of claim 7, wherein the implant is a screw or a nail.

14. A method of treating a maxillary skeletal disorder, comprising:
detecting a maxillary skeletal disorder in a patient;
prescribing a M-MARPE device to correct the maxillary skeletal disorder in the patient;
fabricating the M-MARPE device;
applying the M-MARPE device to the patient; and periodically adjusting the maxillary skeletal expander device by turning a lock screw on the device until a desired result of maxillary skeletal expansion is achieved, the M-MARPE comprising:
two halves of a device body, each half having a left side and a right side, a middle portion, and at least an anchoring leg configured to be fixed directly to a palatine bone, the anchoring leg being affixed or releasably attached to the half of the device body;
at least two arms, each of the at least two arms having a proximal end fixed to one of the two halves of the device body and a distal end extending toward teeth;
a lock screw rotatably coupled to the two halves of the device body and configured to adjust a distance between the two halves of the device body; and
a pair of slide rails for guiding a movement of the two halves of the device body, one slide rail having a first end slidably inserted into or fixed to a first halve of the device body and a second end slidably inserted into a second halve of the device body, and the other slide rail having a first end slidably inserted into or fixed to the second halve of the device body and a second end slidably inserted into the first halve of the device body,
wherein—
the anchoring leg has at least one hole configured to guide an implant to be driven through the hole into the palatine bone so as to fix the anchoring leg to the palatine bone, the at least one hole being optionally angled substantially toward the direction of expansion of the M-MARPE device;
the M-MARPE device optionally further comprises a cover that covers all or substantially all the bottom surface of the M-MARPE device, the cover being releasably attached to the maxillary skeletal expander device; or
two halves of the device body, the two arms, the lock screw, and the pair of slide rails have an antimicrobial surface comprising a antimicrobial agent selected from the group consisting of Ag nanoparticle-TiO2 composite, Ag nanoparticle-polyacrylate hydrogel, Ag nanoparticles with chitosan as a coating, Au nanoparticles, Au nanoparticles and cefaclor in apatite coating, cobalt in resin/polymer, Cu oxide nanocomposites with polyurethane, Cu in diamond-like carbon film, Cu in resin/polymer, ZnO coating, Zn in resin, Zr in resin, BiN₃O₉, C₆H₉BiO₆ coating, Se in hydroxyapatite coating, Mo in resin, chlorohexidine (CHX) digluconate, chlorohexidine digluconate in chitosan coating, chlorohexidine digluconate in polymer coating, fluoridated calcium phosphate coating, polyhexanide, guanidine/2-aminoethyl-methcrylate polymer, Tobramycin (TOB), Vancomycin (VAN), Gentamicin (GEN), Tetracycline (TET), Nystatin (NYT), and combinations of any of these.

15. The method of claim 14, wherein fabricating comprises attaching an anchoring leg to each of the two halves of the device body.

16. The method of claim 14, wherein the M-MARPE comprises a cover that covers all or substantially all the bottom surface of the maxillary skeletal expander device, the cover being releasably attached to the maxillary skeletal expander device.

17. The method of claim 14, wherein the M-MARPE comprises four arms, each of the two halves of the device body having two arms attached thereto, one to its left side and the other to its right side.

18. The method of claim 14, wherein the M-MARPE comprises four anchoring legs, wherein each of the two halves of the device body has two anchoring legs attached to the direction of expansion or to its left and right sides, one to its left end and the other to its right end.

19. The method of claim 14, wherein the M-MARPE further comprises:
a pair of teeth fixing parts, the distal end of each arm attached to one halve of the device body being secured to one of the pair of teeth fixing parts, and the distal end of each arm attached to the other halve of the device body being secured to the other of the teeth fixing parts.

20. The method of claim 14, wherein the implant is a screw or a nail.
